(19) United States
(12) Patent Application Publication
(10) Pub. No.: US 2014/0376467 A1
(43) Pub. Date: Dec. 25, 2014

(54) Method for User Equipment to Select Resource, and Corresponding User Equipment, Computer Program and Storage Medium

(71) Applicants: Yu Liu, Beijing (CN); Chenglin Tu, Beijing (CN)

(72) Inventors: Yu Liu, Beijing (CN); Chenglin Tu, Beijing (CN)

(73) Assignee: ST-Ericsson SA, Plan-les-Ouates (CH)

(21) Appl. No.: 14/344,897

(22) PCT Filed: Sep. 14, 2011
(86) PCT No.: PCT/CN2011/079623

§ 371 Date: Mar. 13, 2014

(51) Int. Cl. H04W 72/10

(52) U.S. Cl. CPC H04W 72/10
USPC 370/329

(57) ABSTRACT

The embodiment of the invention discloses a method for a UE (user equipment) to select a resource, a UE and a computer program. The method for a UE to select a resource comprises: determining resources allocated by a network when the UE needs to transmit HSUPA buffer data in a current frame; selecting a resource transmitting data with a higher efficiency as the resource available to the current frame if the resources comprise a scheduled resource and a non-scheduled resource and transmitting the HSUPA service buffer data with the selected resource. According to an embodiment of the invention, a resource which may transmit more HSUPA service buffer data may be selected between the scheduled resource and the non-scheduled resource, which may improve a utilization ratio of the resources configured by the network to the UE.

### FIELD OF THE INVENTION

This invention relates to a third generation mobile communication field, and particularly to a method for a User Equipment (UE) to select a resource, and corresponding UE, computer program and storage medium.

### BACKGROUND OF THE INVENTION

Even though embodiments of the invention will be described herein in relation to Time Division-High Speed Uplink Packet Access (TD-HSUPA), it should be noted that embodiments of the invention may be equally applicable in other scenarios. Thus, the invention is not limited to TD-HSUPA.

TD-HSUPA services may be divided into a scheduled service and a non-scheduled service. The non-scheduled resource is allocated to a UE by a SRNC (Serving Wireless Network Controller) at a network side. It is already determined when a wireless link is established that the network may only change the allocation of the non-scheduled resource by reallocating the wireless link.

The non-scheduled resource is mainly used for transmitting signals and data which is time sensitive such as constant rate services between the network and the UE.

The scheduled resource is an uplink resource allocated dynamically by a Node B to the UE during real time data transmission, and the uplink resource is a HSUPA resource allocated to the Node B by the SRNC (service wireless network controller) at the network side.

No matter the scheduled resource or the non-scheduled resource, the resource used by the UE mainly includes three kinds of information, which are PRRI (power resource related information), CRRI (code channel resource related information) and TRRI (time slot resource related information).

In a data link layer of a UE protocol stack, a logic channel is used to carry data of an application layer, wherein several logic channels forms a MAC-d flow, and a mapping relationship is determined when a wireless link is established. Specifically, the network may designate which logic channels of the UE corresponds to which MAC-d flow, while different MAC-d flows may be divided into a scheduled MAC-d flow and a non-scheduled MAC-d flow.

The logic channels corresponding to the scheduled MAC-d flow are scheduled logic channels and the UE may only use the scheduled resource allocated temporarily by the Node B at the network side to transmit the data carried by the logic channels. Similarly, data carried by the non-scheduled logic channels may only be transmitted by the non-scheduled resource.

During the HSUPA service data transmission, a MAC layer needs to form a MAC-e PDU according to the resource allocated by the network in every frame and then transmits the MAC-e PDU to the network through the physical layer. However, according to 3GPP 25.321, it is not specified how the UE may select resource in each frame.

If only the scheduled resource or only the non-scheduled resource is available to a frame, the scheduled resource or the non-scheduled resource is used to transmit data on the corresponding logic channels. However, when there are both the scheduled resource and the non-scheduled resource, there is no corresponding method for the UE to transmit data. If the non-scheduled resource always has priority and the scheduled resource is not used, the network may stop allocating the scheduled resource, which will influence data transmission on scheduled logic channels; if the scheduled resource always has priority, the data transmission on non-scheduled logic channels will be influenced and the non-scheduled resources allocated in advance by the network will be wasted. Thus, the UE may utilize resources allocated by SRNC and/or Node B very poorly.

### SUMMARY OF THE INVENTION

According to a first aspect of an embodiment of the invention, a method for a UE to select a resource, and corresponding UE, computer program and storage medium for are provided, which, may improve a utilization ratio of a resource by the UE allocated by a network, for example in TD-HSUPA scenarios.

According to an embodiment of the invention, when there are both a scheduled resource and a non-scheduled resource, the one which may transmit more HSUPA service buffer data is selected so as to improve a utilization ratio of a resource by the UE allocated by the network.

According to an embodiment of the invention, the UE selects the resource corresponding to a larger one between the first data amount that can be transmitted by the scheduled resource and the second data amount that can be transmitted by the non-schedule resource so that the UE may transmit more HSUPA service buffer data with the selected resource. Therefore, the UE may not need to use one resource for a long time while the other resource is wasted, thus improving a utilization ratio of a resource by the UE allocated by the network.

According to an embodiment of the invention, when the first data amount that can be transmitted by the scheduled resource is equal to the second data amount that can be transmitted by the non-schedule resource, the UE selects the resource corresponding to a larger one between a first average priority of at least one logic channel corresponding to the scheduled resource and a second average priority of at least one logic channel corresponding to the non-scheduled resource so that the UE may transmit more HSUPA service buffer data with the selected resource. Therefore, the UE may not need to use one resource for a long time while the other resource is wasted, thus improving a utilization ratio of a resource by the UE allocated by the network.

According to an embodiment of the invention, the UE selects a first smaller one between the first data amount that can be transmitted by the scheduled resource and a third data amount buffered by at least one logic channel corresponding to the scheduled resource as the data amount to be transmitted with a current schedule resource; the UE also selects a second smaller one between the second data amount to be transmitted by the non-scheduled resource and a fourth data amount buffered by at least one logic channel corresponding to the non-scheduled resource as the data amount to be transmitted with a current schedule resource; the UE selects a larger one between the first smaller one and the second smaller one and uses the resource corresponding to the larger one to transmit HSUPA service buffer data so that the UE may transmit more HSUPA service buffer data with the selected resource. Therefore, the UE may not need to use one resource for a long time while the other resource is wasted, thus improving a utilization ratio of a resource by the UE allocated by the network.

According to an embodiment of the invention, the UE selects a first smaller one between the first data amount that can be transmitted by the scheduled resource and a third data amount buffered by at least one logic channel corresponding to the scheduled resource as the data amount to be transmitted with a current schedule resource; the UE also selects a second smaller one between the second data amount to be transmitted by the non-scheduled resource and a fourth data amount buffered by at least one logic channel corresponding to the non-scheduled resource as the data amount to be transmitted with a current schedule resource; if the first smaller one is equal to the second smaller one, the UE selects the resource corresponding to a larger one between a first average priority of at least one logic channel corresponding to the scheduled resource and a second average priority of at least one logic channel corresponding to the non-scheduled resource so that the UE may transmit more HSUPA service buffer data with the selected resource. Therefore, the UE may not need to use one resource for a long time while the other resource is wasted, thus improving a utilization ratio of a resource by the UE allocated by the network.

According to an embodiment of the invention, the UE selects the resource corresponding to a larger one between a first weight of the scheduled resource and a second weight of the non-scheduled resource so that the UE may transmit more HSUPA service buffer data with the selected resource. Therefore, the UE may not need to use one resource for a long time while the other resource is wasted, thus improving a utilization ratio of a resource by the UE allocated by the network.

Additional aspects and advantages of the embodiments of the present disclosure will be given in part in the following descriptions, become apparent in part from the following descriptions, or be learned from the practice of the embodiments of the present disclosure.

### BRIEF DESCRIPTION OF THE DRAWINGS

FIG. 1 is a flow chart showing a method for a UE to select a resource according to a first embodiment of the present invention;

FIG. 2 is a flow chart showing a method for a UE to select a resource according to a second embodiment of the present invention;

FIG. 3 is a flow chart showing a method for a UE to select a resource according to a third embodiment of the present invention;

FIG. 4 is a flow chart showing a method for a UE to select a resource according to a fourth embodiment of the present invention;

FIG. 5 is a flow chart showing a method for a UE to select a resource according to a fifth embodiment of the present invention;

FIG. 6 is a flow chart showing a process for obtaining a first data amount TBSa to be transmitted by the scheduled resource and a second data amount TBSb to be transmitted by the non-scheduled resource according to embodiments of the present invention;

FIG. 7 is a flow chart showing a process for obtaining a first maximum transmission block and a second maximum transmission block according to embodiments of the present invention;

FIG. 8 is a flow chart showing a process for obtaining a third maximum transmission block and a fourth maximum transmission block according to embodiments of the present invention;

FIG. 9 is a block diagram showing a structure of a UE device according to a first embodiment of the present invention; and

FIG. 10 is a block diagram showing a structure of a UE according to a second embodiment of the present invention.

### DETAILED DESCRIPTION OF THE PREFERRED EMBODIMENTS

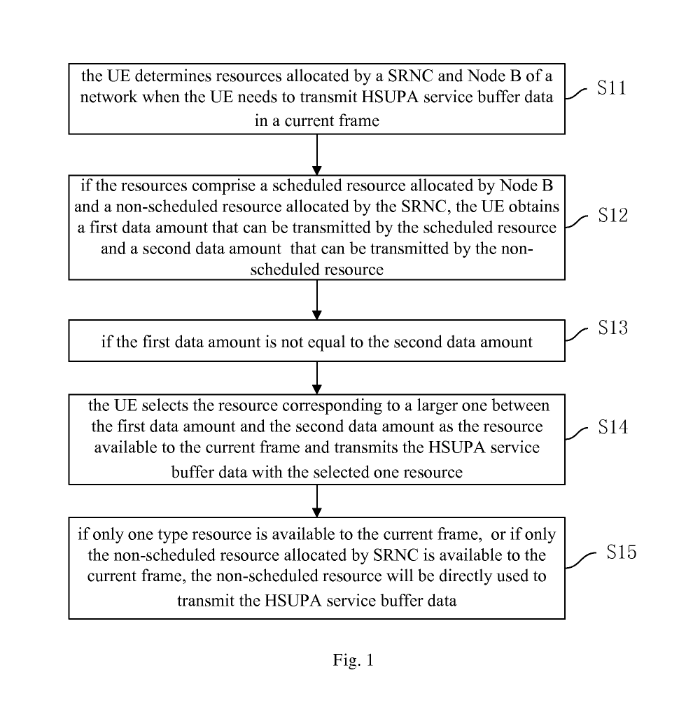

As shown in FIG. 1, a method for a UE to select a resource according to an embodiment of the invention includes the following steps:

Step S11, the UE determines resources allocated by a SRNC and Node B of a network when the UE needs to transmit HSUPA buffer data in a current frame.

Step S12, if the resources include a scheduled resource allocated by Node B and a non-scheduled resource allocated by the SRNC, the UE obtains a first data amount TBSa to be transmitted by the scheduled resource and a second data amount TBSb to be transmitted by the non-scheduled resource.

Step S13, if the first data amount is not equal to the second data amount, progressing to step S14.

Step S14, the UE selects the resource corresponding to a larger one between the first data amount and the second data amount as the resource available to the current frame, and transmits the HSUPA service buffer data with the selected one resource.

Step S15, if only one type resource is available to the current frame, i.e. only the scheduled resource allocated by Node B, the scheduled resource will be directly used to transmit the HSUPA service buffer data; or if only the non-scheduled resource allocated by SRNC is available to the current frame, the non-scheduled resource will be directly used to transmit the HSUPA service buffer data.

According to the above embodiment, the resource corresponding to a larger one between the first data amount and the second data amount is selected so that the UE may use the selected resource to transmit more HSUPA service buffer data. For a smaller one between the first data amount and the second data amount, the UE will not select the resource corresponding to this smaller one and will not use this resource to transmit HSUPA service buffer data, which means this resource may be allocated to other UEs or be released so that when there are both the scheduled resource and the non-scheduled resource, the one which may transmit HSUPA service buffer data more efficiently is selected. Therefore, the UE may not need to use one resource for a long time while the other resource is wasted, thus improving a utilization ratio of a resource by the UE allocated by the network.

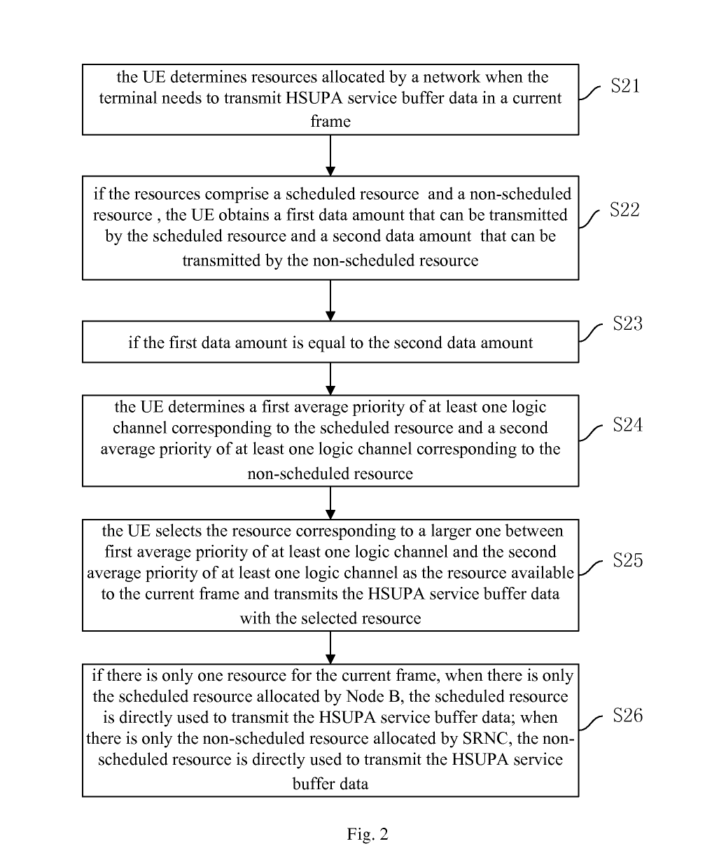

As shown in FIG. 2, a method for a UE to select a resource according to another embodiment of the invention includes the following steps:

Step, S21, the UE determines resources allocated by a SRNC and Node B of a network when the UE needs to transmit HSUPA buffer data in a current frame.

Step S22, if the resources include a scheduled resource allocated by Node B and a non-scheduled resource allocated by the SRNC, the UE obtains a first data amount TBSa to be transmitted by the scheduled resource and a second data amount TBSb to be transmitted by the non-scheduled resource.

Step S23, if the first data amount is equal to the second data amount, progressing to step S24.

Step S24, the UE determines a first average priority of at least one logic channel corresponding to the scheduled resource and a second average priority of at least one logic channel corresponding to the non-scheduled resource. The logic channel is an interface between RLC layer and MAC layer. Logic channels include scheduled logic channels and non-scheduled logic channels. The scheduled logic channels carry scheduled HSUPA service buffer data, which are transmitted by the scheduled resource allocated by Node B. The non-scheduled logic channels carry non-scheduled HSUPA service buffer data, which are transmitted by the non-scheduled resource allocated by SRNC. Logic channels are established when there is a need of service. The priority of the logic channels is pre-allocated when the link is established by the network. For example, when the link is established, if there is only PS service and the PS service is configured to be the scheduled, only one scheduled logic channel may be established and of course two or three or more scheduled logic channels may be established; if there is only one PS service and the PS service is configured to be the non-scheduled, only one non-scheduled logic channel may be established and of course two or three or more non-scheduled logic channels may be established; if there are a plurality of PS services, which are configured to be non-schedule or scheduled, and altogether 15 logic channels are established which have different priorities (the lower the serial number is, the higher the priority is), wherein 5 logic channels may correspond to the scheduled resource and may be configured to be the scheduled, and other 10 logic channels may correspond to the non-scheduled resource and may be configured to be the non-scheduled. Of course, there may be 6 logic channels corresponding to the scheduled resource and 9 logic channels corresponding to the non-scheduled resource. That is to say, there are at least one scheduled logic channel and at least one non-scheduled logic channel.

Step S25, if the first average priority of at least one logic channel corresponding to the scheduled resource is larger than the second average priority of at least one logic channel corresponding to the non-scheduled resource, the UE selects the scheduled resource as a resource available to the current frame and transmits the HSUPA service buffer data with the scheduled resource; if the second average priority of at least one logic channel corresponding to the non-scheduled resource is larger than or equal to the first average priority of at least one logic channel corresponding to the scheduled resource, the UE selects the non-scheduled resource as a resource available to the current frame and transmits the HSUPA service buffer data with the non-scheduled resource.

Step S26, if there is only one resource for the current frame, when there is only the scheduled resource allocated by Node B, the scheduled resource is directly used to transmit the HSUPA service buffer data; when there is only the non-scheduled resource allocated by SRNC, the non-scheduled resource is directly used to transmit the HSUPA service buffer data.

In the above embodiment, if the first data amount is equal to the second data amount, the resource corresponding to a larger one between the first average priority of at least one logic channel corresponding to the scheduled resource and the second average priority of at least one logic channel corresponding to the non-scheduled resource is selected, so that the UE may transmit the data with a higher efficiency, i.e. more HSUPA service buffer data may be transmitted with the selected resource. For a smaller one between the first average priority and the second average priority, the UE will not select the resource corresponding to this smaller one and will not use this resource to transmit HSUPA service buffer data, which means this resource may be allocated to other UEs or be released so that when there are both the scheduled resource and the non-scheduled resource, the one which may transmit more HSUPA service buffer data is selected. Therefore, the UE may not need to use one resource for a long time while the other resource is wasted, thus improving a utilization ratio of a resource by the UE allocated by the network.

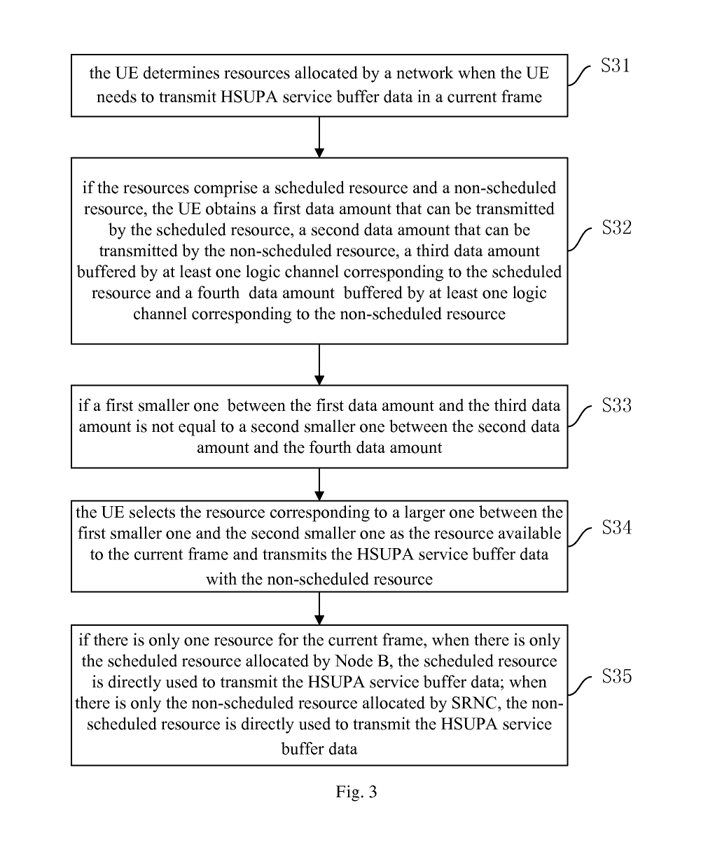

As shown in FIG. 3, a method for a UE to select a resource according to another embodiment of the invention includes the following steps:

Step S31, the UE determines resources allocated by a network when the UE needs to transmit HSUPA buffer data in a current frame.

Step S32, if the resources include a scheduled resource and a non-scheduled resource, the UE obtains a first data amount TBSa to be transmitted by the scheduled resource, a second data amount TBSb to be transmitted by the non-scheduled resource, a third data amount BO_{A} buffered by at least one logic channel corresponding to the scheduled resource and a fourth data amount BO_{B} buffered by at least one logic channel corresponding to the non-scheduled resource.

Step S33, if a first smaller one Min(TBSa, BO_{A}) between the first data amount and the third data amount is not equal to a second smaller one Min(TBSb, BO_{B}) between the second data amount and the fourth data amount, progressing to step S34.

Step S34, the UE selects the resource corresponding to a larger one between the first smaller one and the second smaller one as a resource available to the current frame and transmits the HSUPA service buffer data with the selected resource.

Step S35, if there is only one resource for the current frame, when there is only the scheduled resource allocated by Node B, the scheduled resource is directly used to transmit the HSUPA service buffer data; when there is only the non-scheduled resource allocated by SRNC, the non-scheduled resource is directly used to transmit the HSUPA service buffer data.

In the above embodiment, the resource corresponding to a first smaller one between the first data amount carried by the scheduled resource and the third data amount buffered by at least one logic channel corresponding to the scheduled resource is the actual data amount transmitted by the UE with the scheduled resource; similarly, the resource corresponding to a second smaller one between the second data amount carried by the non-scheduled resource and the fourth data amount buffered by at least one logic channel corresponding to the non-scheduled resource is the actual data amount transmitted by the UE with the non-scheduled resource; the resource corresponding to a larger one between the first smaller one and the second smaller one is selected to transmit the HSUPA service buffer data so that more HSUPA service buffer data may be transmitted by the UE with the selected resource. For a smaller one between the first smaller one and the second smaller one, the UE will not select the resource corresponding to this smaller one and will not use this resource to transmit HSUPA service buffer data, which means this resource may be allocated to other UEs or be released so that when there are both the scheduled resource and the non-scheduled resource, the one which may transmit more HSUPA service buffer data is selected. Therefore, the UE may not need to use one resource for a long time while the other resource is wasted, thus improving a utilization ratio of a resource by the UE allocated by the network.

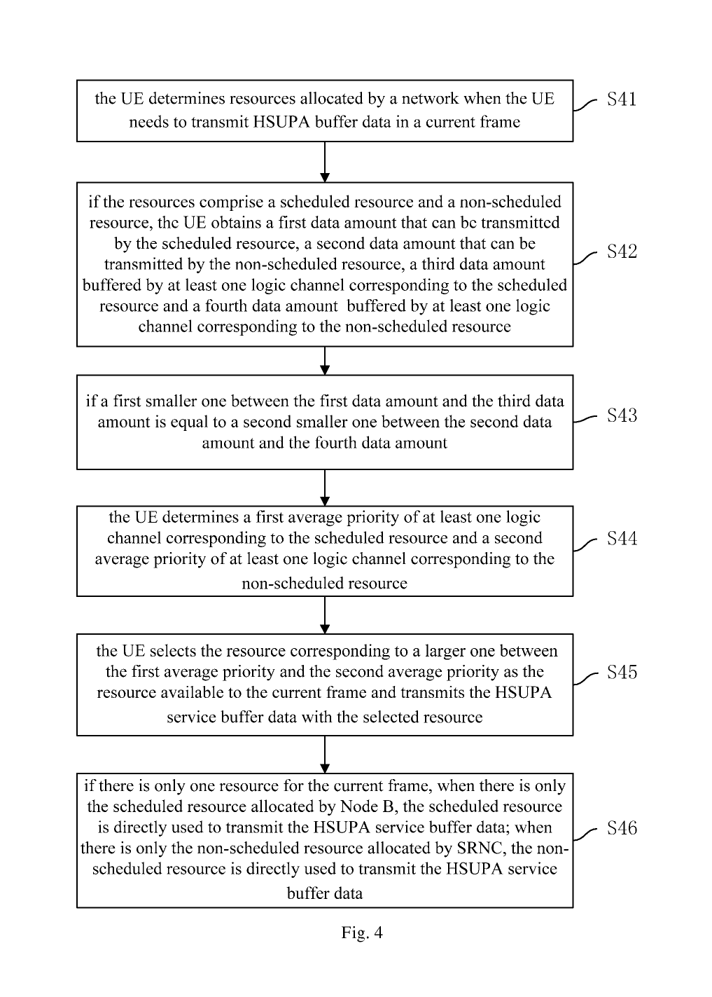

As shown in FIG. 4, a method for a UE to select a resource according to another embodiment of the invention includes the following steps:

Step S41, the UE determines resources allocated by a network when the UE needs to transmit HSUPA buffer data in a current frame.

Step S42, if the resources include a scheduled resource and a non-scheduled resource, the UE obtains a first data amount TBSa to be transmitted by the scheduled resource, a second data amount TBSb to be transmitted by the non-scheduled resource, a third data amount BO_{A} buffered by at least one logic channel corresponding to the scheduled resource and a fourth data amount BO_{B} buffered by at least one logic channel corresponding to the non-scheduled resource.

Step S43, if a first smaller one Min(TBSa, BO_{A}) between the first data amount and the third data amount is equal to a second smaller one Min(TBSb, BO_{B}) between the second data amount and the fourth data amount, progressing to step S44.

Step S44, the UE determines a first average priority of at least one logic channel corresponding to the scheduled resource and a second average priority of at least one logic channel corresponding to the non-scheduled resource.

Step S45, the resource corresponding to a larger one between the first average priority of at least one logic channel corresponding to the scheduled resource P_{A} and the second average priority of at least one logic channel corresponding to the non-scheduled resource P_{B} is selected as a resource available to the current frame and the selected resource is used to transmit the HSUPA service buffer data.

Step S46, if there is only one resource for the current frame, when there is only the scheduled resource allocated by Node B, the scheduled resource is directly used to transmit the HSUPA service buffer data; when there is only the non-scheduled resource allocated by SRNC, the non-scheduled resource is directly used to transmit the HSUPA service buffer data.

In the above embodiment, the resource corresponding to a first smaller one between the first data amount carried by the scheduled resource and the third data amount buffered by at least one logic channel corresponding to the scheduled resource is the actual data amount transmitted by the UE with the scheduled resource; similarly, the resource corresponding to a second smaller one between the second data amount carried by the non-scheduled resource and the fourth data amount buffered by at least one logic channel corresponding to the non-scheduled resource is the actual data amount transmitted by the UE with the non-scheduled resource. If the first smaller one is equal to the second smaller one, the resource corresponding to a larger one between the first average priority of at least one logic channel corresponding to the scheduled resource and the second average priority of at least one logic channel corresponding to the non-scheduled resource is selected to transmit the HSUPA service buffer data so that more HSUPA service buffer data may be transmitted with the selected resource. For a smaller one between the first average priority and the second average priority, the UE will not select the resource corresponding to this smaller one and will not use this resource to transmit HSUPA service buffer data, which means this resource may be allocated to other UEs or be released so that when there are both the scheduled resource and the non-scheduled resource, the one which may transmit more HSUPA service buffer data is selected. Therefore, the UE may not need to use one resource for a long time while the other resource is wasted, thus improving a utilization ratio of a resource by the UE allocated by the network.

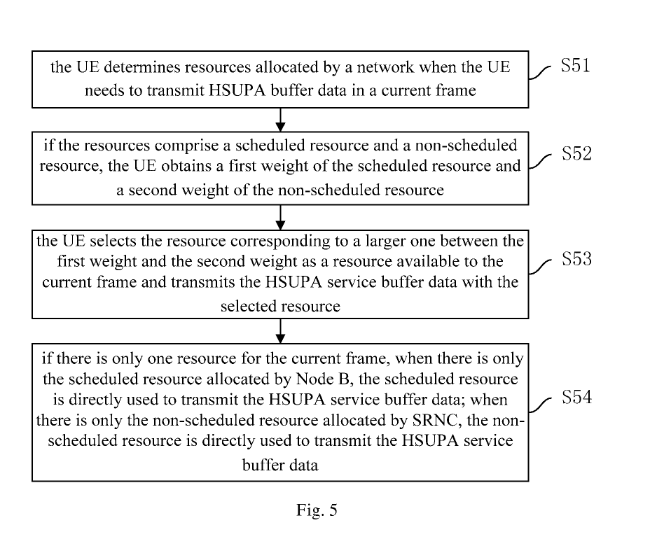

As shown in FIG. 5, a method for a UE to select a resource according to another embodiment of the invention includes the following steps:

Step S51, the UE determines resources allocated by a network when the UE needs to transmit HSUPA buffer data in a current frame.

Step S52, if the resources include a scheduled resource and a non-scheduled resource, the UE obtains a first weight of the scheduled resource and a second weight of the non-scheduled resource.

Step S53, the UE selects the resource corresponding to a larger one between the first weight of the scheduled resource and the second weight of the non-scheduled resource as a resource available to the current frame and transmits the HSUPA service buffer data with the selected resource.

Step S54, if there is only one resource for the current frame, when there is only the scheduled resource allocated by Node B, the scheduled resource is directly used to transmit the HSUPA service buffer data; when there is only the non-scheduled resource allocated by SRNC, the non-scheduled resource is directly used to transmit the HSUPA service buffer data.

In the above embodiment, the resource corresponding to a larger one between the first weight of the scheduled resource and the second weight of the non-scheduled resource is selected to transmit the HSUPA service buffer data so that more HSUPA service buffer data may be transmitted by the UE with the selected resource. For a smaller one between the first weight of the scheduled resource and the second weight of the non-scheduled resource, the UE will not select the resource corresponding to this smaller one and will not use this resource, to transmit HSUPA service buffer data, which means this resource may be allocated to other UEs or be released so that when there are both the scheduled resource and the non-scheduled resource, the one which may transmit more HSUPA service buffer data is selected. Therefore, the UE may not need to use one resource for a long time while the other resource is wasted, thus improving a utilization ratio of a resource by the UE allocated by the network.

In the embodiment shown in FIG. 5, the first weight of the scheduled resource may be:

WSD=BO_{A}×K×P1+P_{A}×(1−K);

the second weight of the non-scheduled resource may be:

WNSD=BO_{B}×K×P2+P_{B}×(1−K)

wherein,

BO_{A} is a data amount buffered by at least one logic channel corresponding to the scheduled resource;

BO_{B} is a data amount buffered by at least one logic channel corresponding to the non-scheduled resource;

P_{A} is an average priority of at least one logic channel corresponding to the scheduled resource;

P_{B} is an average priority of at least one logic channel corresponding to the non-scheduled resource;

P1 and P2 are weight factors;

P1 may be BO_{A}/(BO_{A}+BO_{B}) for making BO_{A} and P_{A} to a same magnitude order;

P2 may be BO_{B}/(BO_{A}+BO_{B}) for making BO_{B} and P_{B} to a same magnitude order; Here, the magnitudes of BO_{A} and BO_{B} are the same and the magnitudes of P_{A} and P_{B} may be the same and the range of K may be 0≦K≦1.

When K=1 and BO_{A}>BO_{B}, the scheduled resource is selected as the resource available to the current frame; when K=1 and BO_{B}>BO_{A}, the non-scheduled resource is selected as the resource available to the current frame.

When K=0 and P_{A}>P_{B}, the scheduled resource is selected as the resource available to the current frame; when K=0 and P_{B}>P_{A}, the non-scheduled resource is selected as the resource available to the current frame.

When 0<K<1, both the data amount buffered by the logic channel and the priority of the logic channel are considered. In practice, if K is 0.4, the priority of the logic channel has a priority over the data amount buffered by the logic channel; when 0<K<0.5, the network configuration has the priority; when 0.5<K<1, the data amount buffered by the logic channel has the priority; and when K=0.5, the network configuration and the data amount buffered by the logic channel have the same priority.

In another embodiment, if the scheduled resource and the non-scheduled resource are in the same frame, if the HSUPA service buffer data BO_{A} buffered by at least one logic channel corresponding to the scheduled resource is larger than a predefined threshold, it means that the data buffered by at least one logic channel corresponding to the scheduled resource is too much and is in an oversaturated state. Therefore, the scheduled resource is selected as the resource available to the current frame and used to transmit the scheduled buffer data.

If the HSUPA service buffer data BO_{B} buffered by at least one logic channel corresponding to the non-scheduled resource is larger than a predefined threshold, it means that the data buffered by at least one logic channel corresponding to the non-scheduled resource is too much and is in an oversaturated state. Therefore, the non-scheduled resource is selected as the resource available to the current frame and used to transmit the non-scheduled buffer data.

If both BO_{A} and BO_{B} are larger than the predefined threshold, the priority of the logic channel may be considered. If P_{A}>P_{B}, the scheduled resource is selected as the resource available to the current frame and used to transmit the scheduled buffer data; if P_{B}>P_{A}, the non-scheduled resource is selected as the resource available to the current frame and used to transmit the non-scheduled buffer data. Therefore, the initial configuration of the network is considered.

In addition, in the embodiments shown in FIG. 1, FIG. 2, FIG. 3 and FIG. 4, the first data amount TBSa to be transmitted by the scheduled resource and the second data amount TBSb to be transmitted by the non-scheduled resource are obtained according to the following steps:

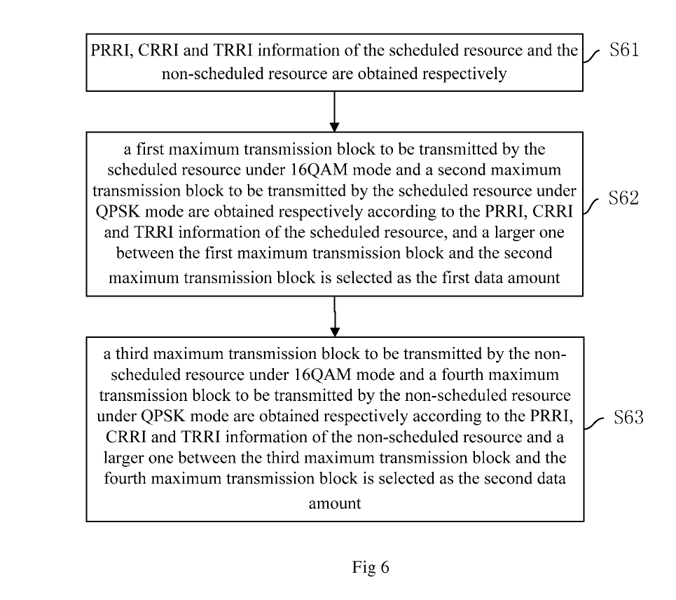

As shown in FIG. 6, Step S61, PRRI, CRRI and TRRI information of the scheduled resource and the non-scheduled resource are obtained respectively.

Step S62, A first maximum transmission block to be transmitted by the scheduled resource under 16QAM mode and a second maximum transmission block to be transmitted by the scheduled resource under QPSK mode are obtained respectively according to the PRRI, CRRI and TRRI information of the scheduled resource, and a larger one between the first maximum transmission block and the second maximum transmission block is selected as the first data amount.

Step S63, a third maximum transmission block to be transmitted by the non-scheduled resource under 16QAM mode and a fourth maximum transmission block to be transmitted by the non-scheduled resource under QPSK mode are obtained respectively according to the PRRI, CRRI and TRRI information of the non-scheduled resource and a larger one between the third maximum transmission block and the fourth maximum transmission block is selected as the second data amount.

In, one embodiment, the first maximum transmission block and the second maximum transmission block are obtained according to the following steps:

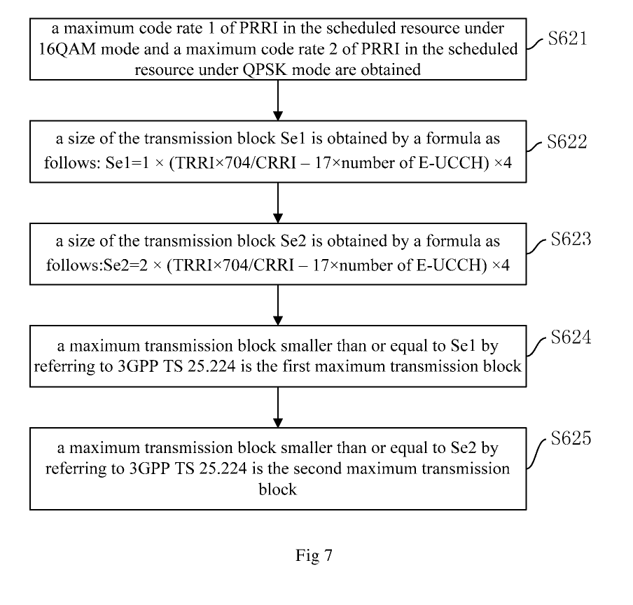

As shown in FIG. 7, Step S621, a maximum code rate λ1 of PRRI in the scheduled resource under 16QAM mode and a maximum code rate λ2 of PRRI in the scheduled resource under QPSK mode are obtained.

Step S622, a′ size of the transmission block Se1 is obtained by a formula as follows:

Sc1=λ1×(TRRI×704/CRRI−17×number of E-UCCH)×4.

Step S623, a size of the transmission block Se2 is obtained by a formula as follows:

Se2=λ2×(TRRI×704/CRRI−17×number of E-UCCH)×4.

Step S624, a maximum transmission block smaller than or equal to Se1 by referring to 3GPP TS 25.224 is the first maximum transmission block.

Step S625, a maximum transmission block smaller than or equal to Se2 by referring to 3GPP TS 25.224 is the second maximum transmission block.

In one embodiment, the third maximum transmission block and the fourth maximum transmission block are obtained according to the following steps:

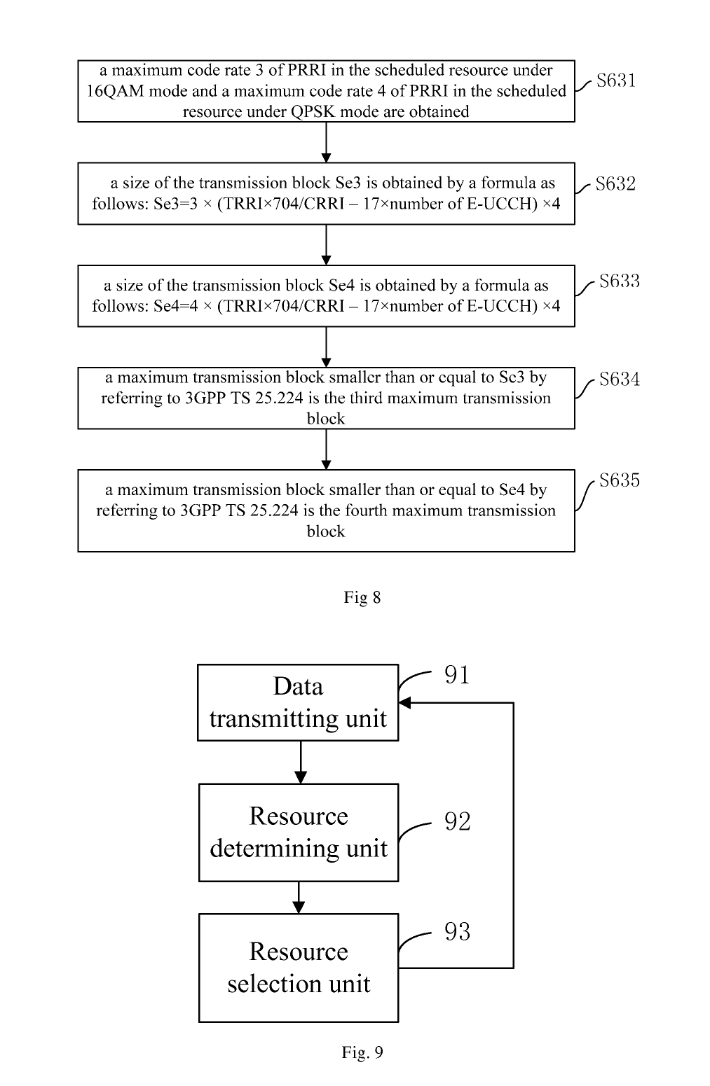

As shown in FIG. 8, Step S631, a maximum code rate λ3 of PRRI in the scheduled resource under 16QAM mode and a maximum code rate λ4 of PRRI in the scheduled resource under QPSK mode are obtained.

Step S632, a size of the transmission block Se3 is obtained by a formula as follows:

Se3=λ3×(TRRI×704/CRRI−17×number of E-UCCH)×4.

Step S633, a size of the transmission block Se4 is obtained by a formula as follows:

Se4=λ4×(TRRI×704/CRRI−17×number of E-UCCH)×4.

Step S634, a maximum transmission block smaller than or equal to Se3 by referring to 3GPP TS 25.224 is the third maximum transmission block.

Step S635, a maximum transmission block smaller than or equal to Se4 by referring to 3GPP TS 25.224 is the fourth maximum transmission block.

In addition, in the embodiments shown in FIG. 2, FIG. 3 and FIG. 4, the first average priority P_{A} of at least one logic channel corresponding to the scheduled resource may be obtained by a formula as follows:

$${P}_{A} = \frac{{\sum }_{1}^{M} {MLP}_{m}}{M}$$

wherein, MLPₘ represents a priority configured by the network to the at least one logic channel corresponding to the scheduled resource

M represents a number of logic channels corresponding to the scheduled resource configured by the network; and

m represents a serial number of the logic channel, m=1, 2, . . . , M;

The second average priority P_{B} of at least one logic channel corresponding to the non-scheduled resource may be obtained by a formula as follows:

$${P}_{B} = \frac{{\sum }_{1}^{N} {MLP}_{n}}{N} ,$$

wherein, MLPₙ represents a priority configured by the network to the at least one logic channel corresponding to the non-scheduled resource;

N represents a number of logic channels corresponding to the non-scheduled resource configured by the network; and

n represents a serial number of the logic channel, n=1, 2, . . . , N.

In all of the above embodiments, when the UE transmits the HSUPA service buffer data with the selected one resource, the UE packs the HSUPA service butter data into a MAC-e PDU packet and transmits to a physical layer and indicates the physical layer to transmit the MAC-e PDU packet with the selected resource.

In all of the above embodiments, when the UE transmits the HSUPA service buffer data, it determines the resource for the current frame. If there is only the scheduled resource, the UE selects the scheduled resource as the resource available to the current frame; if there is only the non-scheduled resource, the UE selects the non-scheduled resource as the resource available to the current frame.

In all of the above embodiments, both the scheduled resource and the non-scheduled resource are the physical resource.

As shown in FIG. 9, An arrangement for a User Equipment, the arrangement includes: a data transmitting unit 91, configured to transmit HSUPA data in a current frame; a resource determining unit 92, configured to determine resources allocated by a network the UE locates in when the UE needs to transmit the HSUPA data; and a resource selection unit 93, configured to select one resource transmitting data with a higher efficiency as a resource available to the current frame if the resources include a scheduled resource and a non-scheduled resource and generates an instruction, instructing the data transmitting unit to transmit the HSUPA buffer data with the selected resource.

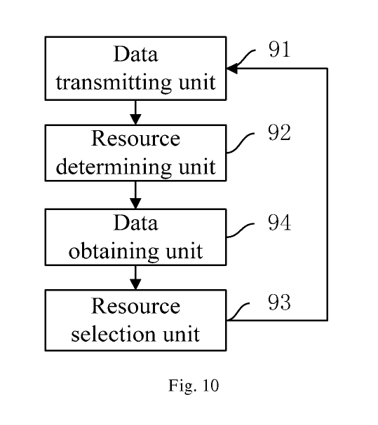

As shown in FIG. 10, the UE may further include a data obtaining unit 94. The data obtaining unit 94 may include a first obtaining unit, a second obtaining unit, a third obtaining unit and/or a fourth obtaining unit.

An embodiment of the UE corresponds to the embodiment shown in FIG. 1. Step S11 is realized by the data transmitting unit 91, step S12 is realized by the resource determining unit 92, step S13 is realized by the first obtaining unit, which is configured to obtain a first data amount TBSa to be transmitted by the scheduled resource and a second data amount TBSb to be transmitted by the non-scheduled resource, and step S14 is realized by the resource selection unit 93, which is configured to select one resource transmitting data with a higher efficiency as a resource available to the current frame according to a size of the first data amount and the second data amount. If the first data amount is not equal to the second data amount, the resource selection unit 93 is further configured to select the resource corresponding to a larger one between the first data amount and the second data amount as the resource available to the current frame.

This embodiment may achieve the same effect as the embodiment shown in FIG. 1.

An embodiment of the UE corresponds to the embodiment shown in FIG. 2. If the first data amount is equal to the second data amount, the UE further includes: a second obtaining unit, configured to obtain a first average priority of at least one logic channel corresponding to the scheduled resource and a second average priority of at least one logic channel corresponding to the non-scheduled resource, wherein if the first average priority is larger than the second average priority, the resource selection unit selects the scheduled resource as the resource available to the current frame and if the second average priority is larger than or equal to the first average priority, the resource selection unit selects the non-scheduled resource as the resource available to the current frame.

This embodiment may achieve the same effect as the embodiment shown in FIG. 2.

An embodiment of the UE corresponds to the embodiment shown in FIG. 3. The UE includes: a third obtaining unit, configured to obtain a first data amount TBSa to be transmitted by the scheduled resource and a second data amount TBSb to be transmitted by the non-scheduled resource and obtain a third data amount BO_{A} buffered by at least one logic channel corresponding to the scheduled resource and a fourth data amount BO_{B} buffered by at least one logic channel corresponding to the non-scheduled resource. The resource selection unit selects a resource transmitting data with a higher efficiency as the resource available to the current frame according to a first smaller one between the first data amount and the third data amount and according to a second smaller one between the second data amount and the fourth data amount. If the first smaller one is larger than the second smaller one, the resource selection unit selects the scheduled resource as a resource available to the current frame; and if the second smaller one is larger than the first smaller one, the resource selection unit selects the non-scheduled resource as a resource available to the current frame.

This embodiment may achieve the same effect as the embodiment shown in FIG. 3.

An embodiment of the UE corresponds to the embodiment shown in FIG. 4. If the first smaller one is equal to the second smaller one, the UE further includes: a fourth obtaining unit, configured to obtain a first average priority of at least one logic channel corresponding to the scheduled resource and a second average priority of at least one logic channel corresponding to the non-scheduled resource. If the first average priority is larger than the second average priority, the resource selection unit selects the scheduled resource as a resource available to the current frame; and if the second average priority is larger than or equal to the second average priority, the resource selection unit selects the non-scheduled resource as a resource available to the current frame.

This embodiment may achieve the same effect as the embodiment shown in FIG. 4.

An embodiment of the UE corresponds to the embodiment shown in FIG. 5. The UE further includes: a fifth obtaining unit, configured to obtain a first weight of the scheduled resource and a second weight of the non-scheduled resource, wherein the resource selection unit selects the resource corresponding to a larger one between the first weight and the second weight as a resource available to the current frame.

The fifth obtaining unit obtains the first weight of the scheduled resource by WSD=BO_{A}×K×P1+P_{A}×(1−K).

The fifth obtaining unit obtains the second weight of the non-scheduled resource by WNSD=BO_{B}×K×P2+P_{B}×(1−K).

WSD is the first weight;

WNSD is the second weight;

BO_{A} is a third data amount buffered by at least one logic channel corresponding to the scheduled resource;

BO_{B} is a fourth data amount buffered by at least one logic channel corresponding to the non-scheduled resource;

P_{A} is a first average priority of at least one logic channel corresponding to the scheduled resource;

P_{B} is a second average priority of at least one logic channel corresponding to the non-scheduled resource;

P1 and P2 are weight factors, and 0≦K≦1.

When K=1 and BO_{A}>BO_{B}, the scheduled resource is selected by the resource selection unit as the resource available to the current frame; when K=1 and BO_{B}>BO_{A}, the non-scheduled resource is selected as the resource available to the current frame.

When K=0 and P_{A}>P_{B}, the scheduled resource is selected by the resource selection unit as the resource available to the current frame; when K=0 and P_{B}>P_{A}, the non-scheduled resource is selected as the resource available to the current frame.

In another embodiment, the first obtaining unit and the third obtaining unit obtain the first data amount and the second data amount by:

obtaining PRRI, CRRI and TRRI information of the scheduled resource and the non-scheduled resource respectively;

obtaining a first maximum transmission block to be transmitted by the scheduled resource under 16QAM mode and a second maximum transmission block to be transmitted by the scheduled resource under QPSK mode according to the PRRI, CRRI and TRRI information of the scheduled resource and selecting a larger one between the first maximum transmission block and the second maximum transmission block as the first data amount; and

obtaining a third maximum transmission block to be transmitted by the non-scheduled resource under 16QAM mode and a fourth maximum transmission block to be transmitted by the non-scheduled resource under QPSK mode according to the PRRI, CRRI and TRRI information of the non-scheduled resource and selecting a larger one between the third maximum transmission block and the fourth maximum transmission block as the second data amount.

The first obtaining unit and the third obtaining unit obtain the first maximum transmission block and the second transmission block includes:

a maximum code rate ζ1 of PRRI in the scheduled resource under 16QAM mode and a maximum code rate λ2 of PRRI in the scheduled resource under QPSK mode are obtained;

a size of the transmission block Se1 is obtained by the formula:

Se1=λ1×(TRRI×704/CRRI−17×number of E-UCCH)×4;

a size of the transmission block Se2 is obtained by the formula:

Se2=λ2×(TRRI×704/CRRI−17×number of E-UCCH)×4;

a maximum transmission block smaller than Se1 by referring to 3GPP TS 25.224 is the first maximum transmission block; and

a maximum transmission block smaller than Se2 by referring to 3GPP TS 25.224 is the second maximum transmission block.

The first obtaining unit and the third obtaining unit obtain the third maximum transmission block and the fourth transmission block includes:

a maximum code rate λ3 of PRRI in the scheduled resource under 16QAM mode and a maximum code rate λ4 of PRRI in the scheduled resource under QPSK mode arc obtained;

a size of the transmission block Se3 is obtained by the formula:

Se3=λ3×(TRRI×704/CRRI−17×number of E-UCCH)×4;

a size of the transmission block Se2 is obtained by the formula:

Se4=λ4×(TRRI×704/CRRI−17×number of E-UCCH)×4;

a maximum transmission block smaller than Se3 by referring to 3GPP TS 25.224 is the third maximum transmission block; and

a maximum transmission block smaller than Se4 by referring to 3GPP TS 25.224 is the fourth maximum transmission block.

The second obtaining unit and the fourth obtaining unit obtain the first average priority P_{A} of at least one logic channel corresponding to the scheduled resource is obtained by the formula:

$${P}_{A} = \frac{{\sum }_{1}^{M} {MLP}_{m}}{M} ,$$

wherein, MLPₘ represents a priority configured by the network to the at least one logic channel corresponding to the scheduled resource,

M represents a number of logic channels corresponding to the scheduled resource configured by the network; and

m represents a serial number of the logic channel, m=1, 2, . . . , M.

The second obtaining unit and the fourth obtaining unit obtain the second average priority P_{B} of at least one logic channel corresponding to the non-scheduled resource is obtained by the formula:

$${P}_{B} = \frac{{\sum }_{1}^{N} {MLP}_{n}}{N} ,$$

wherein, MLPₙ represents a priority configured by the network to the at least one logic channel corresponding to the non-scheduled resource;

N represents a number of logic channels corresponding to the non-scheduled resource configured by the network; and

n represents a serial number of the logic channel, n=1, 2, . . . , N.

In all of the above embodiments, when the data transmitting unit transmits the HSUPA service buffer data with the selected resource, the UE packs the HSUPA service butter data into a MAC-e PDU packet and transmits to a physical layer and indicates the physical layer to transmit the MAC-e PDU packet with the selected resource.

Corresponding to the method for the UE to select resource, an embodiment of the invention further provides a computer program comprising instructions, wherein when the instructions are executed by a processor, the processor performs the above methods.

An embodiment of the invention further provides a storage medium storing the above computer program.

1-21. (canceled)

22. A method for a User Equipment (UE) to select a resource, the method comprising:
a resource determining unit configured to determine resources allocated by a network when transmitting High Speed Uplink Packet Access (HSUPA) data;
a resource selection unit configured to select a resource transmitting data with a higher efficiency as the resource available to the current frame if the resources comprise a scheduled resource and a non-scheduled resource; and
a data transmitting unit configured to transmit HSUPA service buffer data in a current frame with the selected resource.

23. The method of claim 22 wherein selecting a resource further comprises:
obtaining a first data amount that can be transmitted by the scheduled resource and a second data amount that can be transmitted by the non-scheduled resource;
selecting the resource transmitting data with a higher efficiency as the resource available to the current frame according to the first data amount and the second data amount.

24. The method of claim 23 further comprising selecting the resource corresponding to a larger one between the first data amount and the second data amount as the resource available to the current frame if the first data amount is not equal to the second data amount.

25. The method of claim 23 further comprising:
determining a first average priority of at least one logic channel corresponding to the scheduled resource and a second average priority of at least one logic channel corresponding to the non-scheduled resource if the first data amount is equal to the second data amount; and
selecting the resource corresponding to a larger one between the first average priority and the second average priority as the resource available to the current frame.

26. The method of claim 22 wherein selecting a resource further comprises:
obtaining a first data amount that can be transmitted by the scheduled resource and a second data amount that can be transmitted by the non-scheduled resource;
obtaining a third data amount buffered by at least one logic channel corresponding to the scheduled resource and a fourth data amount buffered by at least one logic channel corresponding to the non-scheduled resource; and
selecting the resource transmitting data with a higher efficiency as the resource available to the current frame according to a first smaller one between the first data amount and the third data amount and according to a second smaller one between the second data amount and the fourth data amount.

27. The method of claim 26 wherein:
the scheduled resource is selected as the resource available to the current frame if the first smaller one is larger than the second smaller one; and
the non-scheduled resource is selected as the resource available to the current frame if the second smaller one is larger than the first smaller one.

28. The method of claim 26 wherein:
a first average priority of at least one logic channel corresponding to the scheduled resource and a second average priority of at least one logic channel corresponding to the non-scheduled resource is determined if the first smaller one is equal to the second smaller one; and
the resource corresponding to a larger one between the first average priority and the second average priority is selected as the resource available to the current frame.

29. The method of claim 22 wherein selecting a resource further comprises:
obtaining a first weight of the scheduled resource and a second weight of the non-scheduled resource; and
selecting the resource corresponding to a larger one between the first weight and the second weight as the resource available to the current frame.

30. An arrangement for a User Equipment (UE), the arrangement comprising:
a resource determining unit configured to determine resources allocated by a network when transmitting High Speed Uplink Packet Access (HSUPA) data;
a resource selection unit configured to select a resource transmitting data with a higher efficiency as the resource available to the current frame if the resources comprise a scheduled resource and a non-scheduled resource; and
a data transmitting unit configured to transmit HSUPA service buffer data in a current frame with the selected resource.

31. The arrangement of claim 30 further comprising a first obtaining unit configured to obtain a first data amount that can be transmitted by the scheduled resource and a second data amount that can be transmitted by the non-scheduled resource, wherein the resource selection unit selects the resource transmitting data with a higher efficiency as the resource available to the current frame according to the first data amount and the second data amount.

32. The arrangement of claim 31 wherein the resource selection unit selects the resource corresponding to a larger one between the first data amount and the second data amount as the resource available to the current frame if the first data amount is not equal to the second data amount.

33. The arrangement of claim 31 wherein if the first data amount is equal to the second data amount, the UE further comprises a second obtaining unit configured to obtain a first average priority of at least one logic channel corresponding to the scheduled resource and a second average priority of at least one logic channel corresponding to the non-scheduled resource, wherein the resource selection unit selects the resource corresponding to a larger one between the first average priority and the second average priority as the resource available to the current frame.

34. The arrangement of claim 30 further comprising a third obtaining unit, configured to obtain a first data amount that can be transmitted by the scheduled resource and a second data amount that can be transmitted by the non-scheduled resource and obtain a third data amount buffered by at least one logic channel corresponding to the scheduled resource and a fourth data amount buffered by at least one logic channel corresponding to the non-scheduled resource, wherein the resource selection unit selects the resource transmitting data with a higher efficiency as the resource available to the current frame according to a first smaller one between the first data amount and the third data amount and according to a second smaller one between the second data amount and the fourth data amount.

35. The arrangement of claim 34 wherein:
the resource selection unit selects the scheduled resource as the resource available to the current frame if the first smaller one is larger than the second smaller one; and
the resource selection unit selects the non-scheduled resource as the resource available to the current frame if the second smaller one is larger than the first smaller one.

36. The arrangement of claim 34 wherein if the first smaller one is equal to the second smaller one, the UE further comprises a fourth obtaining unit configured to obtain a first average priority of at least one logic channel corresponding to the scheduled resource and a second average priority of at least one logic channel corresponding to the non-scheduled resource, wherein the resource selection unit selects the resource corresponding to a larger one between the first average priority and the second average priority as the resource available to the current frame.

37. The arrangement of claim 30 further comprising a fifth obtaining unit, configured to obtain a first weight of the scheduled resource and a second weight of the non-scheduled resource, wherein the resource selection unit selects the resource corresponding to a larger one between the first weight and the second weight as the resource available to the current frame.

38. The arrangement of claim 31 wherein the first obtaining unit and the third obtaining unit obtain the first data amount and the second data amount by:
obtaining power resource related information (PRRI), code channel resource related information (CRRI), and time slot resource related information (TRRI) information of the scheduled resource and the non-scheduled resource, respectively;
obtaining a first maximum transmission block to be transmitted by the scheduled resource under 16QAM mode and a second maximum transmission block to be transmitted by the scheduled resource under Quadrature Phase Shift Keying (QPSK) mode according to the PRRI, CRRI and TRRI information of the scheduled resource and selecting a larger one between the first maximum transmission block and the second maximum transmission block as the first data amount; and
obtaining a third maximum transmission block to be transmitted by the non-scheduled resource under 16QAM mode and a fourth maximum transmission block to be transmitted by the non-scheduled resource under QPSK mode according to the PRRI, CRRI and TRRI information of the non-scheduled resource and selecting a larger one between the third maximum transmission block and the fourth maximum transmission block as the second data amount.

39. The arrangement of claim 30 wherein the UE packs the HSUPA service buffer data into a MAC-e Packet Data Unit (PDU) packet and transmits the MAC-e PDU packet to a physical layer and indicates the physical layer to transmit the MAC-e PDU packet with the selected resource when the data transmitting unit transmits the HSUPA service buffer data with the selected one resource.

40. A User Equipment (UE) comprising:
a resource determining unit configured to determine resources allocated by a network when transmitting High Speed Uplink Packet Access (HSUPA) data;
a resource selection unit configured to select a resource transmitting data with a higher efficiency as the resource available to the current frame if the resources comprise a scheduled resource and a non-scheduled resource; and
a data transmitting unit configured to transmit HSUPA service buffer data in a current frame with the selected resource.

41. The UE of claim 40 further comprising a first obtaining unit configured to obtain a first data amount that can be transmitted by the scheduled resource and a second data amount that can be transmitted by the non-scheduled resource, wherein the resource selection unit selects the resource transmitting data with a higher efficiency as the resource available to the current frame according to the first data amount and the second data amount.

42. The UE of claim 41 wherein the resource selection unit selects the resource corresponding to a larger one between the first data amount and the second data amount as the resource available to the current frame if the first data amount is not equal to the second data amount.

43. The UE of claim 41 wherein if the first data amount is equal to the second data amount, the UE further comprises a second obtaining unit configured to obtain a first average priority of at least one logic channel corresponding to the scheduled resource and a second average priority of at least one logic channel corresponding to the non-scheduled resource, wherein the resource selection unit selects the resource corresponding to a larger one between the first average priority and the second average priority as the resource available to the current frame.

44. The UE of claim 40 further comprising a third obtaining unit, configured to obtain a first data amount that can be transmitted by the scheduled resource and a second data amount that can be transmitted by the non-scheduled resource and obtain a third data amount buffered by at least one logic channel corresponding to the scheduled resource and a fourth data amount buffered by at least one logic channel corresponding to the non-scheduled resource, wherein the resource selection unit selects the resource transmitting data with a higher efficiency as the resource available to the current frame according to a first smaller one between the first data amount and the third data amount and according to a second smaller one between the second data amount and the fourth data amount.

45. The UE of claim 44 wherein:
the resource selection unit selects the scheduled resource as the resource available to the current frame if the first smaller one is larger than the second smaller one; and
the resource selection unit selects the non-scheduled resource as the resource available to the current frame if the second smaller one is larger than the first smaller one.

46. The UE of claim 44 wherein if the first smaller one is equal to the second smaller one, the UE further comprises a fourth obtaining unit configured to obtain a first average priority of at least one logic channel corresponding to the scheduled resource and a second average priority of at least one logic channel corresponding to the non-scheduled resource, wherein the resource selection unit selects the resource corresponding to a larger one between the first average priority and the second average priority as the resource available to the current frame.

47. The UE of claim 30 further comprising a fifth obtaining unit, configured to obtain a first weight of the scheduled resource and a second weight of the non-scheduled resource, wherein the resource selection unit selects the resource corresponding to a larger one between the first weight and the second weight as the resource available to the current frame.

48. The UE of claim 41 wherein the first obtaining unit and the third obtaining unit obtain the first data amount and the second data amount by:
obtaining power resource related information (PRRI), code channel resource related information (CRRI), and time slot resource related information (TRRI) information of the scheduled resource and the non-scheduled resource, respectively;
obtaining a first maximum transmission block to be transmitted by the scheduled resource under 16QAM mode and a second maximum transmission block to be transmitted by the scheduled resource under Quadrature Phase Shift Keying (QPSK) mode according to the PRRI, CRRI and TRRI information of the scheduled resource and selecting a larger one between the first maximum transmission block and the second maximum transmission block as the first data amount; and
obtaining a third maximum transmission block to be transmitted by the non-scheduled resource under 16QAM mode and a fourth maximum transmission block to be transmitted by the non-scheduled resource under QPSK mode according to the PRRI, CRRI and TRRI information of the non-scheduled resource and selecting a larger one between the third maximum transmission block and the fourth maximum transmission block as the second data amount.

49. The UE of claim 40 wherein the UE packs the HSUPA service buffer data into a MAC-e Packet Data Unit (PDU) packet and transmits the MAC-e PDU packet to a physical layer and indicates the physical layer to transmit the MAC-e PDU packet with the selected resource when the data transmitting unit transmits the HSUPA service buffer data with the selected one resource.

50. A computer program product comprising a computer-readable medium having instructions stored thereon, wherein when the instructions are executed by a processor, the instructions cause the processor to:
a resource determining unit configured to determine resources allocated by a network when transmitting High Speed Uplink Packet Access (HSUPA) data;
a resource selection unit configured to select a resource transmitting data with a higher efficiency as the resource available to the current frame if the resources comprise a scheduled resource and a non-scheduled resource; and
a data transmitting unit configured to transmit HSUPA service buffer data in a current frame with the selected resource.

51. The computer program product of claim 50 wherein to select a resource, the instructions further cause the processor to:
obtain a first data amount that can be transmitted by the scheduled resource and a second data amount that can be transmitted by the non-scheduled resource;
select the resource transmitting data with a higher efficiency as the resource available to the current frame according to the first data amount and the second data amount.

52. The computer program product of claim 51 wherein to select a resource, the instructions further cause the processor to select the resource corresponding to a larger one between the first data amount and the second data amount as the resource available to the current frame if the first data amount is not equal to the second data amount.

53. The computer program product of claim 51 wherein the instructions further cause the processor to:
determine a first average priority of at least one logic channel corresponding to the scheduled resource and a second average priority of at least one logic channel corresponding to the non-scheduled resource if the first data amount is equal to the second data amount; and
select the resource corresponding to a larger one between the first average priority and the second average priority as the resource available to the current frame.

54. The method computer program product of claim 50 wherein to select a resource, the instructions further cause the processor to:
obtain a first data amount that can be transmitted by the scheduled resource and a second data amount that can be transmitted by the non-scheduled resource;
obtain a third data amount buffered by at least one logic channel corresponding to the scheduled resource and a fourth data amount buffered by at least one logic channel corresponding to the non-scheduled resource; and
select the resource transmitting data with a higher efficiency as the resource available to the current frame according to a first smaller one between the first data amount and the third data amount and according to a second smaller one between the second data amount and the fourth data amount.

55. The computer program product of claim 54, wherein:
the scheduled resource is selected as the resource available to the current frame if the first smaller one is larger than the second smaller one; and
the non-scheduled resource is selected as the resource available to the current frame if the second smaller one is larger than the first smaller one.

56. The computer program product of claim 54 wherein:
a first average priority of at least one logic channel corresponding to the scheduled resource and a second average priority of at least one logic channel corresponding to the non-scheduled resource is determined if the first smaller one is equal to the second smaller one; and
the resource corresponding to a larger one between the first average priority and the second average priority is selected as the resource available to the current frame.

57. The computer program product of 50 wherein the instructions further cause the processor to:
obtain a first weight of the scheduled resource and a second weight of the non-scheduled resource; and
select the resource corresponding to a larger one between the first weight and the second weight as the resource available to the current frame.

58. A computer-readable storage medium having instructions stored thereon, wherein when the instructions are executed by a processor, the instructions cause the processor to:
a resource determining unit configured to determine resources allocated by a network when transmitting High Speed Uplink Packet Access (HSUPA) data;
a resource selection unit configured to select a resource transmitting data with a higher efficiency as the resource available to the current frame if the resources comprise a scheduled resource and a non-scheduled resource; and
a data transmitting unit configured to transmit HSUPA service buffer data in a current frame with the selected resource.
